(19) United States
(12) Patent Application Publication
(10) Pub. No.: US 2013/0284348 A1
(43) Pub. Date: Oct. 31, 2013

(54) TIRE BUILDING DEVICE AND METHOD OF PRODUCING TIRES

(71) Applicant: Florian Fischer, Ebersberg (DE)

(72) Inventor: Florian Fischer, Ebersberg (DE)

(73) Assignee: VMI HOLLAND B.V., Epe (NL)

(21) Appl. No.: 13/991,296

(22) PCT Filed: Nov. 17, 2011
(86) PCT No.: PCT/EP2011/070393

§ 371 Date: Jul. 18, 2013

(30) Foreign Application Priority Data
Dec. 1, 2010 (DE) 10 2010 060 947.1

(51) Int. Cl. B29D 30/30

(52) U.S. Cl. CPC B29D 30/30
USPC 156/117; 156/397

(57) ABSTRACT

A tire building device includes a building drum for applying an inner liner thereon and a winding device for tire cords wherein the building drum is mounted to a drive shaft only on one of its sides, the drive shaft side. The winding device winds the tire cords onto the inner liner in the final shape also on completion of the tire. The winding device, substantially radially, winds the tire cords on the free side opposite the drive shaft transversely across the building drum and past the drive shaft on the drive shaft side.

The invention relates to a tire building device, according to the preamble of claim 1, as well as to a method of producing tires, according to the preamble of claim 9.

It has long been known to build tires having plies of tire cords, i.e. cord, tissue, fibers, belt plies or similar, from the inside wherein—at least with the tubeless tires that have been used for a long time—a thin-walled inner lining, a so-called inner liner, must be air-tight and the tire cords insofar must be covered completely on the inside.

For this purpose, green tires have always been reshaped for a long time, using either an expansion process or a suction process or a combination thereof.

Examples of relatively archaic solutions may be taken from U.S. Pat. No. 1,588,585, but also from DE 861 465. Before this time, i.e. for instance at the turn of the last century but one, most often tires were produced manually out of textile fabric plies and rubber which were applied on top of one another in different ways and which were vulcanised together already back then.

The use of shaping facilities, as has been usual for a long time, however, always suffers the disadvantage that the softer tire components, i.e. natural or synthetic rubber, have to operate against the harder tire components, i.e. for instance the tire cords. However, especially natural rubber is by no means completely homogeneous and when using synthetic rubber it also becomes apparent that warmer areas of the tire are softer and colder areas are harder.

This results in the fact that the position of the tire cords does not change equally during shaping but in an uncontrollable way.

On the other hand, concentric running properties, and even the pressure resistance of the finished tire, depend heavily on the tire cords' even distribution in the carcass. However, it is extremely difficult to control the position of the embedded tire cords during shaping, and this is independent of if the shaping is created by expansion or by producing negative pressure outside of the green tire.

In order to ensure the desired results, it has already been proposed to check the position of the tire cords in retrospect, i.e. for instance before or after vulcanization, by non-destructive materials testing. However, this is very complex, and time-consuming, and tires in which positional changes of the tire cords exceed a predetermined threshold have to be sorted out as discards.

A somewhat newer solution which shows radially expandable rings which are engageable with the belt tire green tire is disclosed in DE 27 23 505 C3. There are also solutions in which expansion is only carried out partially, as can be seen from DE-G 69 23 116. Basically, all these solutions have in common that the position of the tire cords cannot be controlled or only in a limited fashion.

Contrary to this, it is the task of the invention to create a tire building device according to the preamble of claim 1 as well as a method according to the preamble of claim 9 which facilitates especially good concentric running properties of the tire to be finished at low production costs.

This task is inventively solved by claims 1 and 9. Advantageous developments may be taken from the sub claims.

According to the invention the tire building device is provided with a building drum with a constant, i.e. non-expandable, diameter; on said building drum the inner liner is then directly applied as an air-tight layer. Onto this inner liner the tire cords are applied which are preferably themselves already surrounded by elastomer so that they can form an intensive connection with the elastomer of the inner liner without further ado. It is possible to vulcanize the green unit consisting of inner liner and tire cord in order to particularly intensify the connection between these two elements.

According to the invention a radial winding of the tire cords around the building drum takes place. Insofar, according to the invention, a radial belt tire is produced which does not exclude an additional provision of tire cord plies which are diagonal or extend in the direction of the circumference.

The exact and unchangeable positioning of the tire cords—which are additionally distributed very evenly around the circumference—leads surprisingly to substantially improved concentric running properties and also a higher resisting force against centrifugal forces so that the inventively produced tire may also be used as a high-speed tire.

According to the invention it is especially favorable if the tire cords run as exactly radially as possible. For this purpose, the building drum is mounted preferably at one side and rotates with the drive shaft flange-mounted at that position. However, it is also possible to have a mounting on both sides and to take any suitable measures for radially guiding the tire cords. For instance, for driving it is also possible to alternate so that the building drum is always mounted at that side at which the tire cord is not being guided during winding. Alternatively, the inner liner can also be caused to tumble in a way and can be wound in the meantime, i.e. practically without being really mounted. A further possibility is to provide a mounting on both sides and to provide a redirection of the tire cords around the axles or shafts via pins or any other means which are located in a radial inner area.

For the provision of the inventive wide building device it is crucial that the core winding is cut by the cutting device during winding or after winding. As the tire cords are rubberized, it is enough for them to adhere sufficiently to the inner liner such that cutting can already take place half a turn after the winding process. Alternatively, of course, the inner area can also be cut out after conclusion of all turns, i.e. of the whole winding.

For the radial winding the tire cord is guided via the center of the free side of the building drum, and on the drive shaft side the tire cord is either guided tightly around the drive shaft so that a substantially radial extension occurs, or an exactly radial application is carried out until a redirection pin in an adjacent disposition to the drive shaft is reached, at which redirection pin the tire cord will then be redirected around the drive shaft.

It is especially advantageous that there is the inventive possibility of making the tire cords run radially across the free side and across the drive shaft side of the building drum. This presents the opportunity to create an ideal symmetry and evenness in the distance of the tire cords also in the tread area of the future tire which is not influenced by a possible shifting, as can be seen in the state of the art. Of course, this does not exclude a crowning or cambering in a way known per se.

Coating the tire cords with elastomer, natural rubber, synthetic rubber or similar ensures an especially good connection between the tire cord on the one hand and the surrounding tire mass on the other hand.

The hardness of the tire cord elastomers can be adjusted in any suitable way whereas it is preferred that their hardness is slightly larger than the hardness of the surrounding rubber mass, in particular the hardness of the inner liner.

According to the invention it is also especially favorable that an inventive tire can be built up in an automated fashion. The winding device can be formed by a robotic arm and the cutting of the circular cut-out in the center of the area of the free side surface and the drive shaft side can be carried out in an automated fashion. The cut can be provided in any suitable way, for instance by laser or water jet, whereas it is to be understood that the remaining length of the tire cords is preferably chosen such that a folding of the ends of the tire cords together with the rubber mixture around the bead bundle and the bead apices that are possibly mounted to it is possible without further ado.

Further advantages, details and features emerge from the following description of several exemplary embodiments of the invention with reference to the drawing.

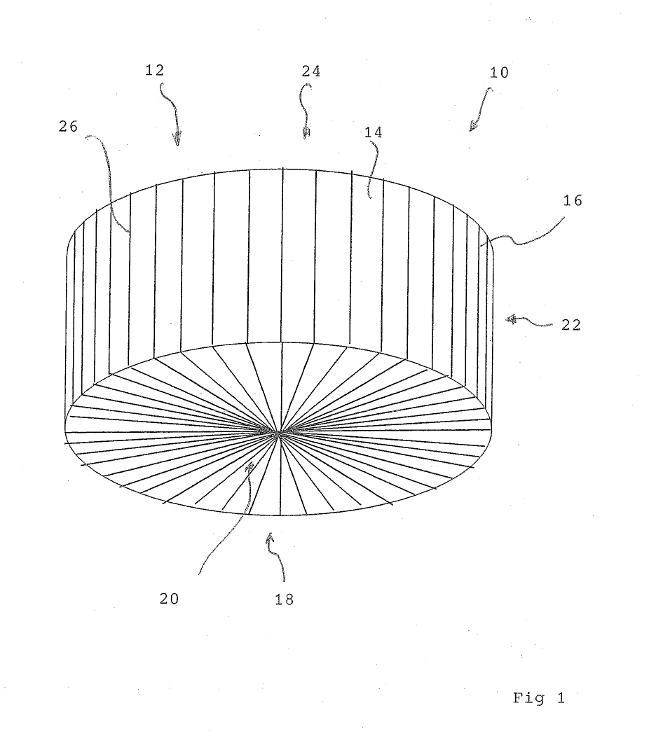

FIG. 1 shows a schematic view of an inventive building drum of an inventive tire building device comprising applied tire cords, in a first embodiment of the invention;

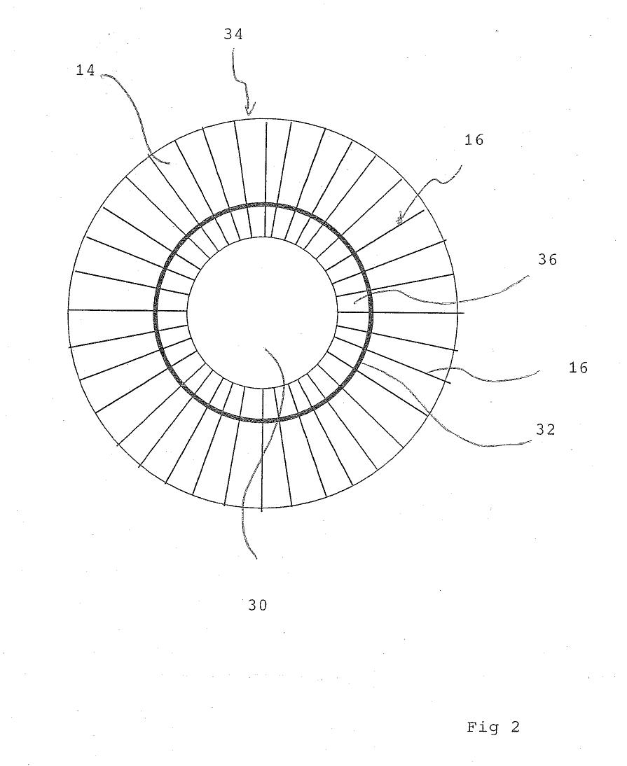

FIG. 2 shows the shape of the green tire produced in this way viewed in front view, also in a schematic illustration;

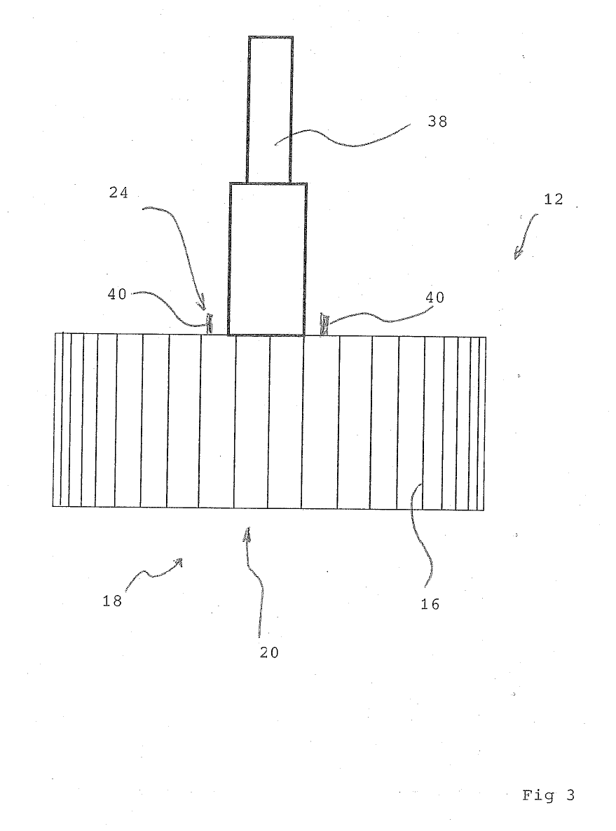

FIG. 3 shows a side view of an inventive building drum onto which the inner liner and the tire cords are mounted, in a schematic illustration;

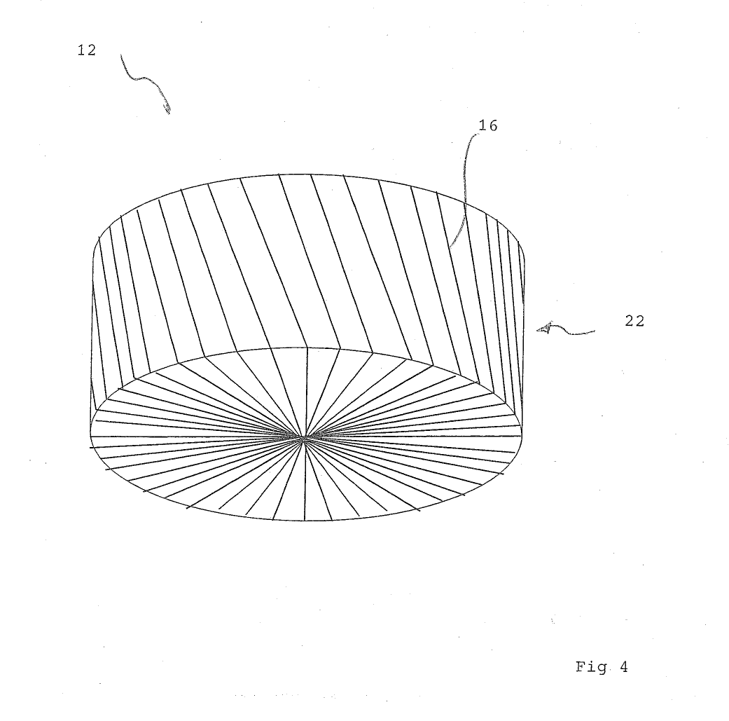

FIG. 4 shows a further embodiment of the green tire in a schematic illustration; and

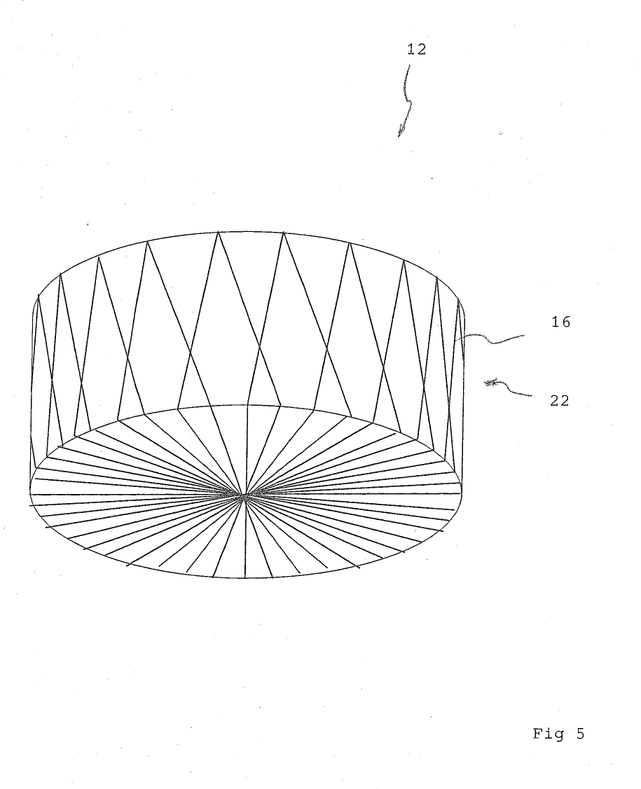

FIG. 5 shows a further embodiment of the green tire in a schematic illustration.

The tire building device 10 illustrated schematically in FIG. 1 comprises a building drum 12 which is evenly coated with an inner liner 14 in a special way according to the invention. As can be seen from FIG. 1, the tire cord 16 is wound onto the combination of building drum 12 and inner liner 14. Winding is carried out such that the tire cord 16 extends transversely across the free side 18, i.e. at least approximately extends through its central area 20, then crosses the external cylinder surface or peripheral surface 22 of the building drum 12, and subsequently crosses the drive shaft side 24 of the building drum 12 and subsequently to this goes back again via the peripheral surface 22 at the position opposite to the first position.

In the course of this winding process, the building drum 12 turns by a certain predetermined angle rate which corresponds to a tangential offset of the winding loops 26 of the tire cords 16. This tangential offset corresponds to the angle distance of each winding loop of the tire cord 16, and the distance of the winding loops on the peripheral surface 22 is exactly the same when viewed across the circumference of the future tire. Although not illustrated here, it is to be understood that the joint between the ends of the tire cords is located preferably in the central area 20, such that it can be cut later and the evenness of the extension of the future individual tire cords 16 cannot be compromised.

The winding of the tire cord 16 is preferably produced through a circular robotic arm of a winding device not shown in the figures. For the provision of the desired angle offset the building drum 12 is mounted on a drive shaft which can be seen in FIG. 3 and is described subsequently.

FIG. 2 shows the way in which the tire cords 16 extend. The extension takes place in a radial direction, viewed across the free side 18. FIG. 2 shows a circular cut-out 30 which cuts off the central area 20 according to FIG. 1. Here, a bead bundle 32 has already been placed upon which terminates the green tire 34 of the tire on the rim side, as known per se. A projection measure 36 of the tire cords 16 past the bead bundle 32 is selected such that a folding of the tire cords 36—together with the inner liner 14—over the bead bundle 32 back towards the outside is possible without further ado.

FIG. 3 shows the way in which the building drum 12 is mounted on a drive shaft 38. The drive shaft 38 extends unilaterally from the building drum 12. It is attached to an area opposite to the central area 20 on the drive shaft side 24 of the building drum 12 and connected to it non-rotatably.

Therefore, the drive shaft 38 extends across the radial center which is insofar not free for the winding process, in contrast to the free side 18.

In order to still facilitate a radial extension of the tire cords 16, redirection pins 40 are disposed closely next to the drive shaft 38, namely in a number which corresponds to the number of the winding loops of the tire cords 16. Every winding loop of the tire cord 16 is now directed via a redirection pin 40, and from there guided around the drive shaft 38 and subsequently to the opposite redirection pin 40 and there again redirected such that still an exactly radial layout of the tire cords—at least outside of the central area 20 which will later be cut anyway—can be realized.

FIG. 4 shows that the tire cords 16 can also extend transversely in the area of the tread 22. This tire cord picture can be produced without further ado by suddenly rotating the building drum 12 during the winding process across the tread 22 slightly more strongly.

It is also possible to produce several windings of tire cords 16. This can be seen in FIG. 5 which shows a crossing of the tire cords 16 in the area of the tread. In this embodiment two tire cords are applied without further ado whereas the building drum 12 rotates in one direction when the first tire cord is applied, and the building drum 12 rotates in the other direction when the second tire cord 16 is applied.

1-15. (canceled)

16. A tire building device comprising a building drum for applying an inner liner thereon and a winding device for tire cords, characterized in that the winding device winds the tire cords (16) onto the inner liner (14) approximately in the final shape which also exists after completion of the tire, and that the winding device, substantially radially, winds the tire cords (16) on a free side (18) opposite the drive shaft (38) transversely across the building drum (12) and past the drive shaft (38) on a drive shaft side (24) and that a cutting device, in particular a laser-cutting device or a water-jet cutting device, cuts the tire cords at least after completion of one turn, in particular after completion of the whole winding, in the form of a circular cutout at a position spaced apart from the circumference and also from the drive shaft, removing a circular center of the combination of tire cords and inner liner and leaving enough material to fold the ends of the tire cords around a bead bundle of the tire.

17. The tire building device according to claim 16, characterized in that the building drum (12) has an unchangeable outer shape corresponding to the inner shape of the tire to be produced, and that the inner liner (14) is directly applied onto the outer shape.

18. The tire building device according to claim 16, characterized in that the inner liner (14) is applied onto the outer shape of the building drum (12) in the form of a rubber sheet.

19. The tire building device according to claim 16, characterized in that the inner liner (14) is applied onto the outer shape of the building drum (12) by a second winding device.

20. The tire building device according to claim 16, characterized in that the tire cords (16) are coated with rubber, in particular with synthetic rubber, and are in particular produced in an extruder.

21. The tire building device according to claim 16, characterized in that the winding device has a guide arm which revolves around the building drum (12), namely transversely across the free side (18), subsequently axially parallel across the circumference of the building drum (12), subsequently transversely across the drive shaft side (24) and subsequently axially parallel in the opposite direction across the circumference of the building drum (12).

22. The tire building device according to claim 16, characterized in that the drive shaft (38) and the winding device are synchronized with each other in such a way that the tire cords (16) are wound around the inner liner (14) at the same distance to one another.

23. The tire building device according to claim 16, characterized in that to the building drum (12) adjacent to the drive shaft (38) axially parallel pins are attached which allow a radial layout of the tire cords (16) on the drive shaft side (24) and at which the tire cords (16) are redirected.

24. A method of producing tires, using a building drum onto which an inner liner is applied, as well as using a winding device for tire cords, characterized in that the inner liner is directly applied to the building drum, subsequently the tire cord is wound onto the inner liner by the winding device, the tire cord being guided transversely across the building drum on a free side opposite the drive shaft and substantially radially past the drive shaft on a drive shaft side, removing a circular center of the combination of tire cords and inner liner and leaving enough material to fold the ends of the tire cords around a bead bundle of the tire.

25. The method according to claim 24, characterized in that the tire cord(s) is/are wound to have a shape which they will also assume in the future tire.

26. The method according to claim 24, characterized in that after completion of the winding process by the winding device a circular center of the combination of tire cords and inner liner is removed, in particular by laser-cutting or by any other cutting process, leaving enough material to fold the ends of the tire cords around a bead bundle of the tire.

27. The method according to claim 24, characterized in that the tire cords are guided at least partially diagonally across the future tread of the tire and in particular cross one another at that position.

28. The method according to claim 24, characterized in that the winding device during winding holds the tire cord under a controlled tension which keeps the compression forces of the winding support on the inner liner substantially constant during winding-up.

29. The method according to claim 24, characterized in that the winding device winds the tire cords onto the inner liner in the final shape which also exists after completion of the tire.

30. The method according to claim 24, characterized in that the winding device winds the tire cords onto the inner liner so that they assume a shape that is smaller, in particular by less than 30% smaller, than the final shape at completion of the tire, and that the green tire produced in this way is then caused, in particular stretched, to assume the final shape.

31. The tire building device according to claim 17, characterized in that the inner liner (14) is applied onto the outer shape of the building drum (12) in the form of a rubber sheet.

32. The tire building device according to claim 17, characterized in that the inner liner (14) is applied onto the outer shape of the building drum (12) by a second winding device.

33. The method according to claim 25, characterized in that after completion of the winding process by the winding device a circular center of the combination of tire cords and inner liner is removed, in particular by laser-cutting or by any other cutting process, leaving enough material to fold the ends of the tire cords around a bead bundle of the tire.

34. The method according to claim 25, characterized in that the tire cords are guided at least partially diagonally across the future tread of the tire and in particular cross one another at that position.

35. The method according to claim 26, characterized in that the tire cords are guided at least partially diagonally across the future tread of the tire and in particular cross one another at that position.
